(19) United States
(12) Patent Application Publication
(10) Pub. No.: US 2026/0061804 A1
(43) Pub. Date: Mar. 5, 2026

(54) INTEGRATED SYSTEM OF VEHICLE AIR CONDITIONING AND COOLING OR HEATING DEVICE, AND CONTROL METHOD THEREOF

(71) Applicant: Zhongshan Broad-Ocean Motor Co., Ltd., Zhongshan (CN)

(72) Inventors: Chuping LU, Zhongshan (CN); Xuanfeng WEN, Zhongshan (CN); Hongyu JIA, Zhongshan (CN)

(21) Appl. No.: 19/382,208

(22) Filed: Nov. 6, 2025

Related U.S. Application Data
(63) Continuation-in-part of application No. PCT/CN2024/121060, filed on Sep. 25, 2024.

(30) Foreign Application Priority Data
Jun. 1, 2024 (CN) 202410702042.3

(51) Int. Cl. B60H 1/00

(52) U.S. Cl. CPC B60H 1/00828

(57) ABSTRACT

An integrated system of vehicle air conditioning and a cooling or heating device, including a primary ventilation system and a cooling or heating device. The primary ventilation system includes an air intake duct, an HVAC system, and an air supply duct. The air intake duct includes a fresh air inlet and a recirculated air inlet. The HVAC system includes a high-power air supply fan and a heat exchanger; an outlet of the HVAC system is connected to the air supply duct. A plurality of end air supply systems are respectively disposed at openings of the air outlet ducts; each of the end air supply systems includes a low-power air supply fan and a low-speed fan. The cooling or heating device includes a plurality of end pipes disposed at the end of the air supply duct; a cooling fan is disposed inside each end pipe.

### CROSS-REFERENCE TO RELATED APPLICATIONS

This application is a continuation-in-part of International Patent Application No. PCT/CN2024/121060 with an international filing date of Sep. 25, 2024, designating the United States, now pending, further claims foreign priority benefits to Chinese Patent Application No. 202410702042.3 filed Jun. 1, 2024. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to an integrated system of vehicle air conditioning and a cooling or heating device, and a control method thereof.

Traditional automotive HVAC (Heating, Ventilation, and Air Conditioning) centralized air delivery systems typically comprise an air intake duct, a refrigeration/heating system, and an air delivery duct. As shown in FIGS. 1 and 2, the air intake duct is equipped with two inlets: one inlet 1a for introducing fresh air and another inlet 2a for introducing internal recirculated air. The outlet of the air intake duct is connected to the refrigeration/heating system, whose outlet is in turn connected to the air delivery duct. The refrigeration/heating system includes a high-power blower fan 3a, an evaporator 4a, a compressor, an expansion valve, a condenser, and a cooling fan. This system cools (or heats) the air from the intake duct and delivers it to the air delivery duct. The distal end of the air delivery duct branches into multiple outlet ducts 5a, with the openings of these outlets situated in different zones of the passenger cabin. The terminus of each outlet duct is typically fitted with a damper to regulate the airflow volume.

Conventional automotive HVAC air delivery systems suffer from the following drawbacks:

1. The high-power blower fan is generally bulky and located within the engine compartment, which significantly constrains the spatial layout and design flexibility of that area.

2. After being propelled by the high-power blower fan, the conditioned air (cooled or heated) travels through the air delivery duct. Particularly for rear-seat zones requiring long duct runs, substantial airflow and pressure losses occur, detrimentally impacting the overall energy efficiency of the system.

3. The centralized system delivers unconditioned air directly from the blower fan to the outlet vents and onto the passengers. This results in overly rapid changes in perceived skin temperature for the passengers, leading to reduced comfort levels.

4. The system lacks capability for differentiated airflow management at individual outlets. Passengers in different seating positions cannot independently set desired fan speeds specific to their location. Control is limited to adjusting dampers at various outlets, which merely restricts airflow, resulting in wasted energy and an inability to meet personalized comfort preferences.

5. The direct delivery of unconditioned air from the central blower to passengers, as mentioned, creates uncomfortable drafts and rapid temperature perception changes.

6. Traditionally, fresh air ventilation relies on ram air pressure generated by the vehicle’s forward motion to force outside air into the cabin. This incoming air is unmanaged regarding its temperature and humidity, adversely affecting the interior climate control, increasing the HVAC system’s energy consumption to counteract its effect, and ultimately compromising passenger comfort.

Furthermore, with the advancement of new energy electric vehicles (EVs), the three core components—the drive motor, the power battery, and the motor controller—are identified as the primary sources of significant heat generation during operation, making their thermal management systems critically important. Conventionally, liquid cooling has been the predominant method employed. This approach involves routing liquid coolant through dedicated piping to dissipate heat from the drive motor and the motor controller. However, the implementation of liquid cooling circuits introduces challenges related to sealing integrity, resulting in product structures that are inherently more complex, manufacturing costs that are elevated, and overall system integration that is less optimized.

Through research and experimentation, it has been determined that while the drive motor, being the most significant heat source, necessitates liquid cooling for adequate heat dissipation, the power battery and the motor controller generate comparatively lower levels of heat during operation. Consequently, for these components, air cooling can suffice to meet the essential heat dissipation requirements. Utilizing air cooling can effectively mitigate the various complications associated with liquid cooling pipelines, thereby simplifying the system architecture and reducing manufacturing costs.

Additionally, in severely cold climates, the thermal management strategy for EV components must address not only heat dissipation but also the crucial need to maintain the power battery and the motor controller within an optimal temperature range to ensure proper startup and operation. Therefore, there is a recognized need in the art for a newly designed system capable of effectively regulating the operating temperature of both the power battery and the motor controller.

### SUMMARY

The disclosure provides an integrated system of vehicle air conditioning and a cooling or heating device, comprising a primary ventilation system and a cooling or heating device. The primary ventilation system comprises an air intake duct, a HVAC system, and an air supply duct; the air intake duct comprises a fresh air inlet and a recirculated air inlet; an outlet of the air intake duct is connected to the HVAC system; the HVAC system comprises a high-power air supply fan and a heat exchanger; an outlet of the HVAC system is connected to the air supply duct, and an end of the air supply duct is provided with a plurality of air outlet ducts; a plurality of end air supply systems are respectively disposed at openings of the air outlet ducts; each of the end air supply systems comprises a low-power air supply fan and a low-speed fan; the low-power air supply fan is disposed at one end of a corresponding air outlet duct, and the low-speed fan is disposed beside an opening of the air outlet duct; the end air supply systems are configured to mix a low/high-temperature airflow output by the HVAC system with an ambient indoor airflow and direct mixed air to passengers in a passenger compartment. The cooling or heating device comprises a plurality of end pipes disposed at the end of the air supply duct; a cooling fan is disposed inside each end pipe; the cooling fan uses the low/high-temperature airflow output by the HVAC system to dissipate heat from or heat a vehicle’s power battery and/or drive control system.

In a class of this embodiment, the end air supply systems are controlled by and operates under a central control system; the cooling fan of the cooling or heating device is also controlled by and operates under the central control system; a temperature sensor is disposed on the power battery and/or the drive control system; the temperature sensor detects an operating temperature of the power battery and/or the drive control system and transmits this data to the central control system; based on the operating temperature of the power battery and/or the drive control system, the central control system utilizes the cooling fan to direct the low/high-temperature airflow output from the HVAC system to dissipate heat from or heat the power battery and/or the drive control system on the vehicle.

In a class of this embodiment, the integrated system further comprises a fresh air exchange unit; the fresh air exchange unit comprises a first pipe and a second pipe; an air intake fan is disposed inside the first pipe; under the operation of the air intake fan, the first pipe actively draws fresh air into the passenger compartment; an exhaust fan is disposed inside the second pipe; an inlet of the second pipe is connected to the passenger compartment; under the operation of the exhaust fan, an outlet of the second pipe discharges stale air from the passenger compartment to outside.

In a class of this embodiment, two air intake fans are disposed within the first pipe and adjacent to two ends of the first pipe respectively; and two exhaust fans are disposed within the second pipe and adjacent to two ends of the second pipe, respectively.

In a class of this embodiment, the air intake fans and the exhaust fans both employ high-speed compact fans for ducted applications.

In a class of this embodiment, the end air supply systems further comprise an air supply control unit; the air supply control unit controls the operation of the high-speed, low-power air supply fan and the low-speed fan within its respective end air supply system; and the central control system controls the operation of each air supply control unit.

In a class of this embodiment, the air intake fans and the exhaust fans are controlled by and operate under the central control system 6; the first pipe is further equipped with an air conditioning unit, which comprises a filter, a cooling coil, and a humidifier. A fresh air temperature sensor and a fresh air damper are disposed at the fresh air inlet end of the first pipe; the fresh air temperature sensor transmits detected temperature signals to the central control system, which accordingly controls the operation of the fresh air damper and the air conditioning unit.

In a class of this embodiment, the HVAC system further comprises a compressor, an expansion valve, a condenser, and a cooling fan.

In a class of this embodiment, the power battery is configured to supply power to a drive motor of the vehicle, and the drive control system is configured to control the operation of the drive motor.

The disclosure also provides a control method for an integrated system of vehicle air conditioning and a cooling or heating device, the method comprising:

sensing a temperature of a power battery or a drive control system via a temperature sensor, when the temperature is outside an effective operating temperature range of the power battery or the drive control system, transmitting a signal to a central control system via the temperature sensor;

controlling, by the central control system, a cooling fan to direct cooled or heated air output from a HVAC system toward the power battery or the drive control system, thereby dissipating heat from or heating the power battery or the drive control system until the temperature of the power battery or the drive control system reaches a predetermined operating temperature range; and

automatically deactivating the cooling fan or reducing a rotational speed of the cooling fan via the central control system.

The following advantages are associated with the integrated system of vehicle air conditioning and a cooling or heating device of the disclosure.

1. The integration of the vehicle air conditioning system with the cooling or heating device, along with the air-cooled design for the power battery and/or drive control system, incorporates the cooling or heating device within the vehicle air conditioning system. The cooling or heating device comprises a plurality of end pipes connected to the end of the air supply duct, each equipped with a cooling fan. The cooling fan utilizes the low/high-temperature airflow output from the HVAC system to dissipate heat from or heat the vehicle’s power battery and/or drive control system. This integration simplifies the overall structure, reduces manufacturing costs, and achieves a high level of integration.

2. The integrated system of the disclosure comprises a plurality of end pipes at the end of the air supply duct, each end pipe disposed with a cooling fan. Simultaneously, by monitoring the temperature of the battery or drive system and implementing centralized automatic control through the central control system, comprehensive utilization and centralized management of the energy used for vehicle air conditioning and cooling systems are achieved. This results in improved vehicle energy conservation.

3. The control method of the disclosure effectively maintains the operating temperature of the power battery or drive control system, making the vehicle suitable for both extreme cold and high-temperature operating environments. Thereby, the method prolongs the service life of the vehicle, reduces the incidence of failures, and offers simple and reliable control.

### BRIEF DESCRIPTION OF THE DRAWINGS

FIG. 1 is a schematic diagram of a conventional automotive HVAC centralized air delivery system;

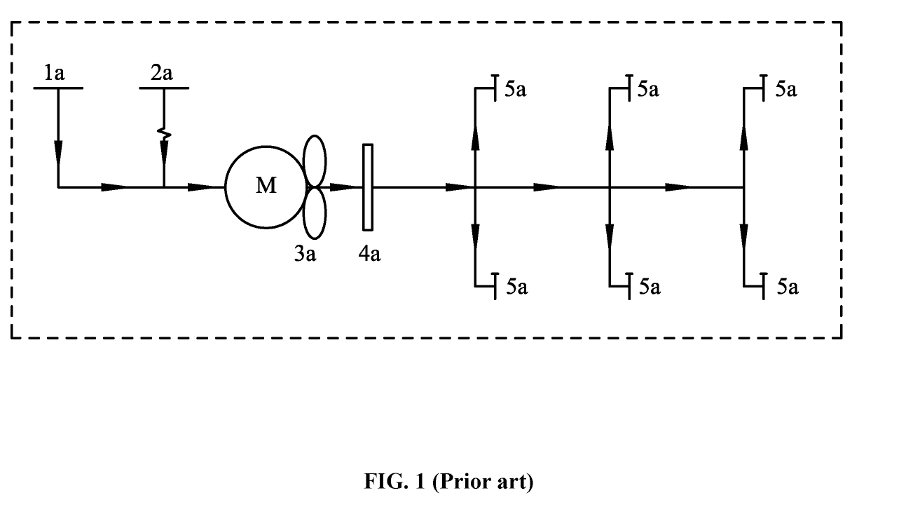

FIG. 2 is a schematic diagram of a HVAC system of a conventional automotive HVAC centralized air delivery system;

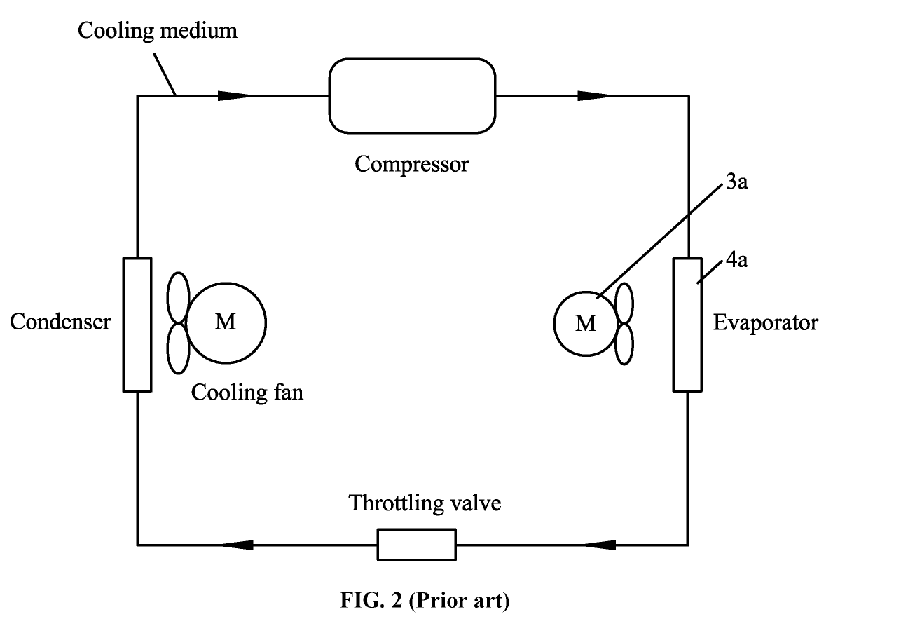

FIG. 3 is a schematic diagram of a primary ventilation system in Example 1 of the disclosure;

FIG. 4 is a schematic diagram of a cooling or heating device in Example 1 of the disclosure;

FIG. 5 is a schematic diagram of a primary ventilation system integrated with a fresh air exchange unit in Example 1 of the disclosure;

FIG. 6 is a structural block diagram of an integrated system of vehicle air conditioning and a cooling or heating device of the disclosure; and

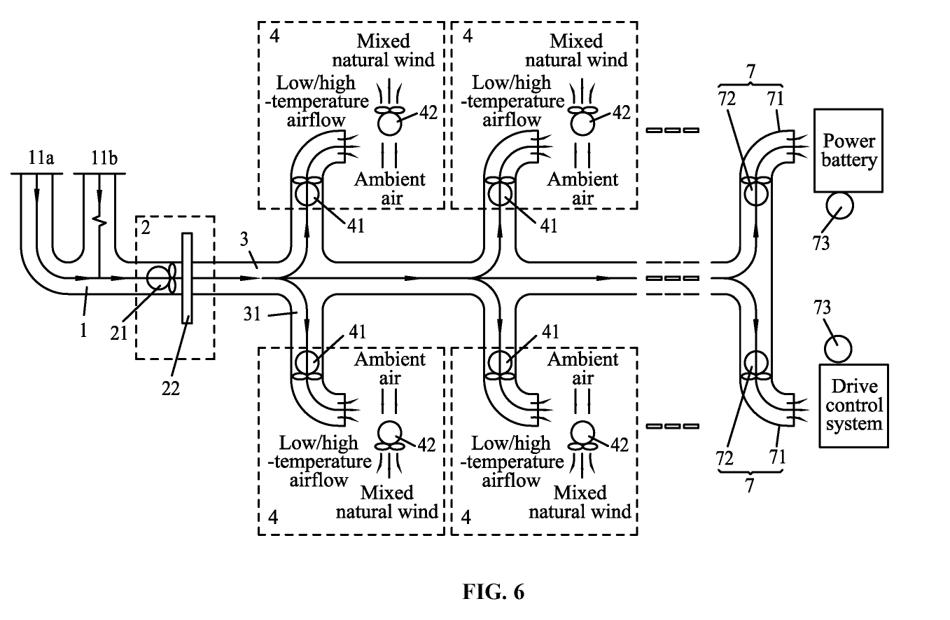

FIG. 7 is a control block diagram of an integrated system of vehicle air conditioning and a cooling or heating device of the disclosure.

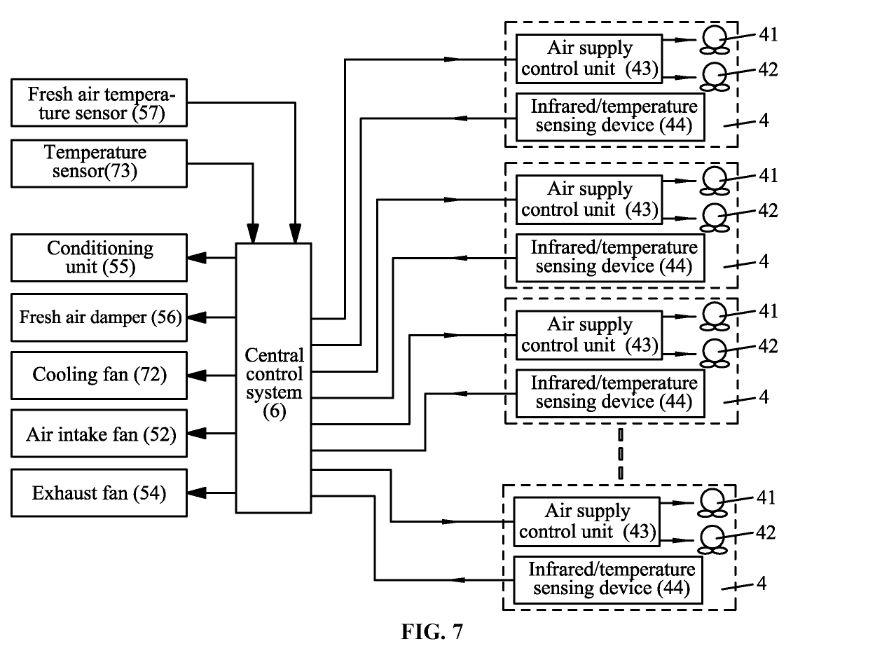

### DETAILED DESCRIPTION

To further illustrate the disclosure, embodiments detailing an integrated system of vehicle air conditioning and a cooling or heating device are described below. It should be noted that the following embodiments are intended to describe and not to limit the disclosure.

### Example 1

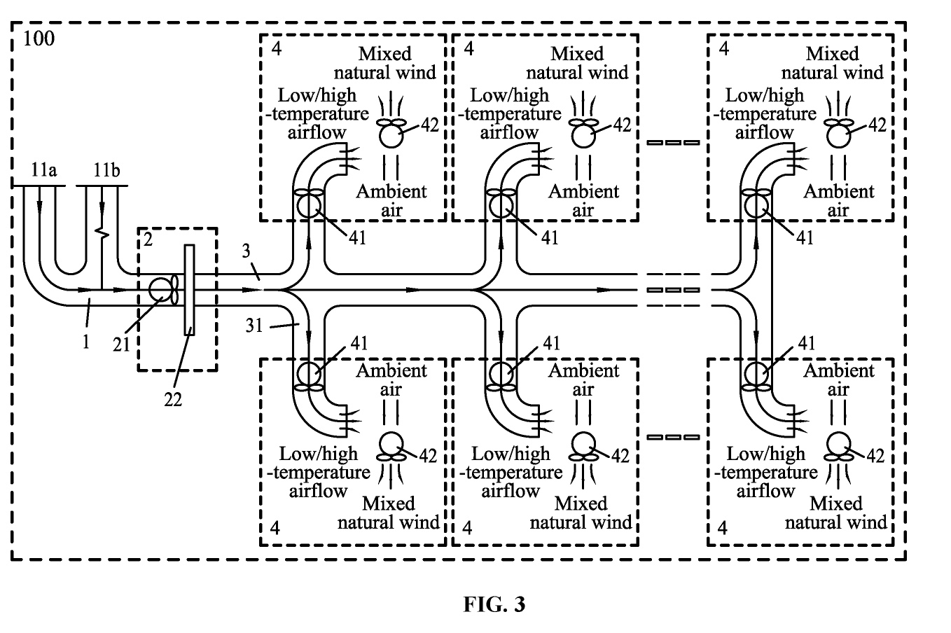

As shown in FIGS. 3- 7, the disclosure provides an integrated system of vehicle air conditioning and a cooling or heating device. The integrated system comprises a primary ventilation system 100.

The primary ventilation system 100 comprises an air intake duct 1, a HVAC system 2, and an air supply duct 3. The air intake duct 1 comprises a fresh air inlet 11a and a recirculated air inlet 11b. The outlet of the air intake duct 1 is connected to the HVAC system 2. The HVAC system 2 comprises a high-power air supply fan 21 and a heat exchanger 22. The outlet of the HVAC system 2 is connected to the air supply duct 3, and the end of the air supply duct 3 is provided with a plurality of air outlet ducts 31. A plurality of end air supply systems 4 are respectively disposed at the openings of the air outlet ducts 31. Each of the end air supply systems 4 comprises a low-power air supply fan 41 and a low-speed fan 42. The low-power air supply fan 41 is disposed at the end of a corresponding air outlet duct 31, and the low-speed fan 42 is disposed beside the opening of the air outlet duct 31. The end air supply system 4 mixes the low/high-temperature airflow output by the HVAC system 2 with the ambient indoor airflow and directs the mixed air to the users in the passenger compartment.

The primary ventilation system 100 further comprises a cooling or heating device 7. The cooling or heating device 7 comprises a plurality of end pipes 71 disposed at the end of the air supply duct 3. A cooling fan 72 is disposed inside each end pipe 71. The cooling fan 72 uses the low/high-temperature airflow output by the HVAC system 2 to dissipate heat from or heat the vehicle’s power battery and/or the drive control system.

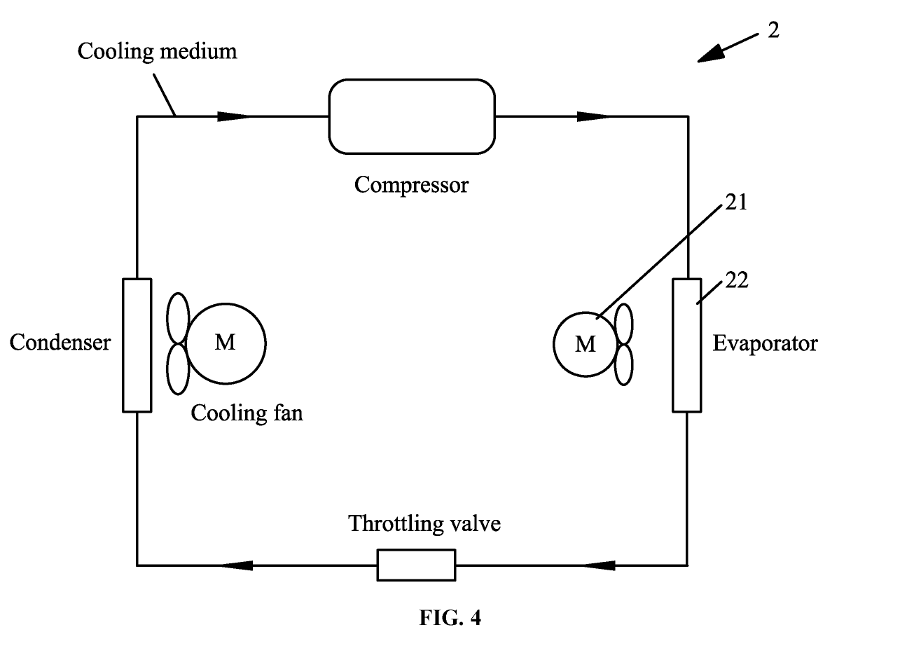

As shown in FIG. 4, the HVAC system 2 further comprises a compressor, an expansion valve, a condenser, and a cooling fan.

The end air supply system 4 is controlled by and operates under a central control system 6. The cooling fan 72 of the cooling or heating device 7 is also controlled by and operates under the central control system 6. A temperature sensor 73 is disposed on the power battery and/or the drive control system. The temperature sensor 73 detects the operating temperature of the power battery and/or the drive control system and transmits this data to the central control system 6. Based on the operating temperature of the power battery and/or the drive control system, the central control system 6 utilizes the cooling fan 72 to direct the low/high-temperature airflow output from the HVAC system 2 to dissipate heat from or heat the power battery and/or the drive control system on the vehicle.

Advantages of the integrated system of the disclosure are summarized as follows: 1. The integration of the vehicle air conditioning system with the cooling or heating device, along with the air-cooled design for the power battery and/or drive control system, incorporates the cooling or heating device within the vehicle air conditioning system. The cooling or heating device comprises a plurality of end pipes connected to the end of the air supply duct, each equipped with a cooling fan. The cooling fan utilizes the low/high-temperature airflow output from the HVAC system to dissipate heat from or heat the vehicle’s power battery and/or drive control system. This integration simplifies the overall structure, reduces manufacturing costs, and achieves a high level of integration. 2. The integrated system of the disclosure comprises a plurality of end pipes at the end of the air supply duct, each end pipe disposed with a cooling fan. Simultaneously, by monitoring the temperature of the battery or drive system and implementing centralized automatic control through the central control system 6, comprehensive utilization and centralized management of the energy used for vehicle air conditioning and cooling systems are achieved. This results in improved vehicle energy conservation.

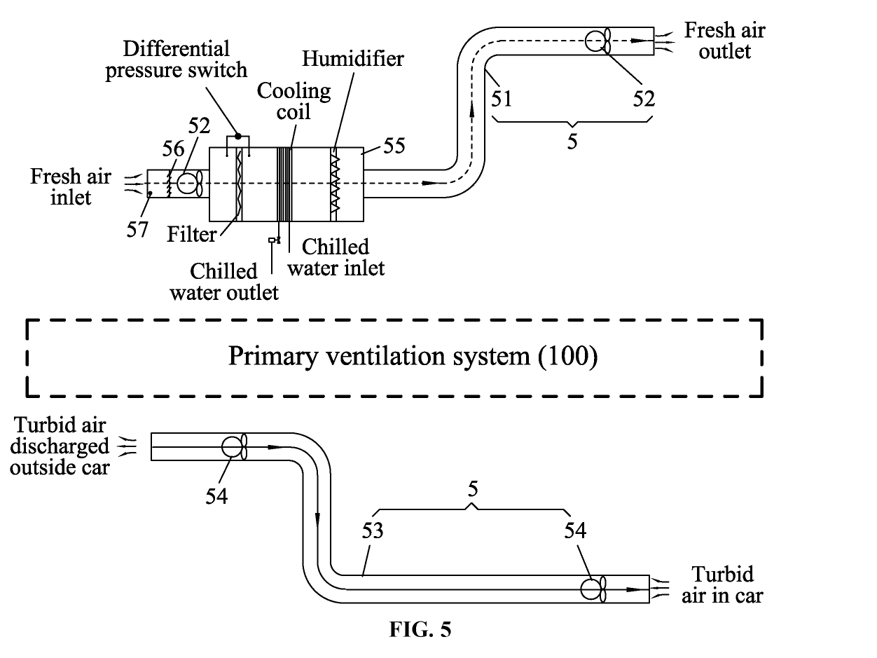

As shown in FIG. 5, the integrated system of vehicle air conditioning and cooling or heating device further comprises a fresh air exchange unit 5. The fresh air exchange unit 5 comprises a first pipe 51 and a second pipe 53. An air intake fan 52 is disposed inside the first pipe 51. Under the operation of the air intake fan 52, the first pipe 51 actively draws fresh air into the passenger compartment. An exhaust fan 54 is disposed inside the second pipe 53. The inlet of the second pipe 53 is connected to the passenger compartment. Under the operation of the exhaust fan 54, the outlet of the second pipe 53 discharges stale air from the passenger compartment to the outside.

Fans are disposed within the first pipe 51 and the second pipe 53, specifically at the front and rear sections of the pipes, respectively. The two fans create a siphoning effect within the pipes, generating negative pressure and thereby improving the airflow volume and energy efficiency of the fan system. The air intake fan 52 and the exhaust fan 54 can be centrally controlled via the central control system 6 of the air conditioning system. This enables effective management of the energy consumption of the vehicle air conditioning system and enhances passenger comfort.

The air intake fan 52 and exhaust fan 54 both employ high-speed compact fans for ducted applications.

The end air supply system 4 is controlled by and operates under the central control system 6.

The exhaust fan 54 is controlled by and operates under the central control system 6.

The low-power air supply fan 41 is positioned diagonally behind the low-speed fan 42. The high-speed, low-power air supply fan 41 directs the low/high-temperature airflow from the HVAC system 2 to the area behind the low-speed fan 42. The low-speed fan 42 then mixes this low/high-temperature airflow with the ambient temperature airflow and directs the mixture towards the user location. This mixing process performed by the low-speed fan 42 results in more comfortable air temperature and velocity for the user.

The end air supply system 4 further comprises an air supply control unit 43. The air supply control unit 43 controls the operation of the high-speed, low-power air supply fan 41 and the low-speed fan 42 within its respective end air supply system 4. The central control system 6 controls the operation of each air supply control unit 43.

Users in different locations can set the airflow velocity of their respective end air supply system 4 according to their individual needs, thereby better satisfying personalized comfort requirements and enhancing the user experience. The air supply control unit 43 may specifically be an integrated motor controller capable of simultaneously controlling both the low-power air supply fan 41 and the low-speed fan 42. The central control system 6 corresponds to the central control system of the air conditioning system, which will not be elaborated in detail here.

The end air supply system 4 further comprises an infrared/temperature sensing device 44. The infrared/temperature sensing device 44 detects the status of the user’s location and transmits the sensing signals to the central control system 6. Based on these sensing signals, the central control system 6 controls the operation of each respective air supply control unit 43. The central control system 6 can differentially control the operation of each individual end air supply system 4.

Both the low-power air supply fan 41 and the low-speed fan 42 feature adjustable airflow direction, which can be regulated within an angular range of 10 to 90 degrees, for example.

The status of the user’s location comprises user presence detection, temperature detection, and sleep state detection.

By utilizing the infrared/temperature sensing device 44 to identify whether a seat is occupied, whether the user is in a sleep state, and whether the user’s body temperature is too high or too low, the central control system automatically adjusts to the optimal temperature and airflow velocity for different user locations. This not only improves user comfort but also enhances energy efficiency and conservation.

Both the air intake fan 52 and the exhaust fan 54 are controlled by and operate under the central control system 6. The first pipe 51 is further equipped with an air conditioning unit 55, which comprises a filter, a cooling coil, and a humidifier. A fresh air temperature sensor 57 and a fresh air damper 56 are disposed at the fresh air inlet end of the first pipe 51. The fresh air temperature sensor 57 transmits detected temperature signals to the central control system 6, which accordingly controls the operation of the fresh air damper 56 and the air conditioning unit 55. The central control system 6 regulates the opening or closing of the fresh air damper 56 to control the intake of fresh air.

Through improvements to the primary ventilation system, the vehicle features higher energy efficiency and enhanced passenger comfort. The advantages are summarized as follows:

1. In automotive applications, the conventional high-power centralized air supply fan located in the engine compartment is eliminated. Instead, a high-power air supply fan 21 is incorporated into the centralized air supply duct. This modification allows for better spatial arrangement within the engine compartment, thereby enhancing the rationality of the spatial design.

2. In automotive applications, the airflow delivered by the high-power air supply fan 21 is supplemented by high-speed, low-power air supply fans incorporated at the terminal sections of the outlet ducts. This configuration creates a siphoning effect within the ducts, generating negative pressure that reduces airflow decay of the cooled (or heated) air throughout the duct system, thereby improving the overall air delivery efficiency of the fan system.

3. In automotive applications, each air outlet duct 31 is equipped with an independent air supply control unit 43, which individually controls the low-power air supply fan 41 of the respective duct. Simultaneously, a central control system 6 integrated within the central console provides centralized management, enabling differential control of the operational speed of the low-power air supply fan 41 in each air outlet duct 31.

4. The installation of a low-power air supply fan 41 in each air outlet duct 31 allows passengers in different locations to individually set the rotational speed of their respective fan according to personal preference. This better accommodates individualized comfort requirements, thereby enhancing passenger satisfaction.

5. The incorporation of an infrared/temperature sensing system 44 in each air outlet duct 31 enables detection of seat occupancy, recognition of a sleep state, and monitoring of whether a passenger’s body temperature is too high or too low. The central control system 6 then automatically adjusts to the optimal temperature and airflow velocity for each passenger location, improving comfort levels.

6. The addition of a low-speed fan 42 to each air outlet duct 31 allows ambient air to mix with the cooled (or heated) air delivered by the low-power air supply fan 41 before being directed toward the passengers. This creates a natural wind-like airflow, significantly enhancing comfort.

7. The novel air conditioning air supply system enables constant air volume control, mitigating the risk of reduced airflow due to increased duct static pressure caused by factors such as filter clogging. This improves the consistency of the cooling effect experienced by passengers.

### Example 2

As shown in FIGS, 6 and 7, a control method for the integrated system of vehicle air conditioning and a cooling or heating device in Example 1 comprises the following steps: sensing a temperature of the power battery or drive control system through the temperature sensor 73; when the temperature is outside the effective operating temperature range of the power battery or drive control system, transmitting a signal to the central control system 6 through the temperature sensor; automatically controlling, by the central control system 6, the cooling fan 72 to direct cooled or heated air output from the HVAC system 2 toward the power battery or drive control system, thereby dissipating heat from or heating the power battery or drive control system until the temperature of the power battery or drive control system reaches a predetermined safe operating temperature; and automatically deactivating the cooling fan 72 or reducing an operational speed of the cooling fan 72 by the central control system 6. This process is repeated cyclically.

A specific example is described as follows. Assume the appropriate operating temperature range for the power battery is set between T1 and T2, where T1 equals 25 degrees Celsius and T2 equals 40 degrees Celsius. The temperature sensor 73 installed on the power battery senses the current battery temperature T0. When T0 is less than T1, the central control system 6 automatically controls the cooling fan 72 to direct heated air output from the HVAC system 2 toward the power battery, thereby raising its temperature. When the operating temperature of the power battery reaches the T1-T2 range, the central control system 6 automatically deactivates the cooling fan 72 or reduces its operational speed. When T0 is greater than T2, the central control system 6 automatically controls the cooling fan 72 to direct cooled air output from the HVAC system 2 toward the power battery, thereby lowering its temperature. When the operating temperature of the power battery returns to the T1-T2 range, the central control system 6 automatically deactivates the cooling fan 72 or reduces its operational speed. This process is cyclically repeated. Furthermore, the operation of the HVAC system 2 is controlled by the central control system 6. The specific temperature control principle for the drive control system follows the same logic as that for the power battery, though its appropriate operating temperature range may differ slightly—for instance, ranging from 20 degrees Celsius to 45 degrees Celsius.

The control method of the disclosure effectively maintains the operating temperature of the power battery or drive control system, making the vehicle suitable for both extreme cold and high-temperature operating environments. Thereby, the method prolongs the service life of the vehicle, reduces the incidence of failures, and offers simple and reliable control.

It will be obvious to those skilled in the art that changes and modifications may be made, and therefore, the aim in the appended claims is to cover all such changes and modifications.

What is claimed is:

1. An integrated system of vehicle air conditioning and a cooling or heating device, comprising:
a primary ventilation system, the primary ventilation system comprising an air intake duct, a heating, ventilation, and air conditioning (HVAC) system, and an air supply duct; and
a cooling or heating device;
wherein:
the air intake duct comprises a fresh air inlet and a recirculated air inlet; an outlet of the air intake duct is connected to the HVAC system; the HVAC system comprises a high-power air supply fan and a heat exchanger; an outlet of the HVAC system is connected to the air supply duct, and an end of the air supply duct is provided with a plurality of air outlet ducts; a plurality of end air supply systems are respectively disposed at openings of the plurality of air outlet ducts; each of the end air supply systems comprises a low-power air supply fan and a low-speed fan; the low-power air supply fan is disposed at one end of a corresponding air outlet duct, and the low-speed fan is disposed beside an opening of the air outlet duct; the end air supply systems are configured to mix a low/high-temperature airflow output by the HVAC system with an ambient indoor airflow and direct mixed air to passengers in a passenger compartment; and
the cooling or heating device comprises a plurality of end pipes disposed at the end of the air supply duct; a cooling fan is disposed inside each end pipe; the cooling fan uses the low/high-temperature airflow output by the HVAC system to dissipate heat from or heat a vehicle’s power battery and/or drive control system.

2. The integrated system of claim 1, wherein the end air supply systems are controlled by and operates under a central control system; the cooling fan of the cooling or heating device is also controlled by and operates under the central control system; a temperature sensor is disposed on the power battery and/or the drive control system; the temperature sensor detects an operating temperature of the power battery and/or the drive control system and transmits this data to the central control system; based on the operating temperature of the power battery and/or the drive control system, the central control system utilizes the cooling fan to direct the low/high-temperature airflow output from the HVAC system to dissipate heat from or heat the power battery and/or the drive control system on the vehicle.

3. The integrated system of claim 2, further comprising a fresh air exchange unit; wherein the fresh air exchange unit comprises a first pipe and a second pipe; an air intake fan is disposed inside the first pipe; under the operation of the air intake fan, the first pipe actively draws fresh air into the passenger compartment; an exhaust fan is disposed inside the second pipe; an inlet of the second pipe is connected to the passenger compartment; under the operation of the exhaust fan, an outlet of the second pipe discharges stale air from the passenger compartment to outside.

4. The integrated system of claim 3, wherein two air intake fans are disposed within the first pipe and adjacent to two ends of the first pipe, respectively; and two exhaust fans are disposed within the second pipe and adjacent to two ends of the second pipe, respectively.

5. The integrated system of claim 4, wherein the air intake fans and the exhaust fans both employ high-speed compact fans for ducted applications.

6. The integrated system of claim 1, wherein the end air supply systems further comprise an air supply control unit; the air supply control unit controls the operation of the low-power air supply fan and the low-speed fan within its respective end air supply system; and the central control system controls the operation of each air supply control unit.

7. The integrated system of claim 4, wherein the air intake fans and the exhaust fans are controlled by and operate under the central control system; the first pipe is further equipped with an air conditioning unit comprising a filter, a cooling coil, and a humidifier; a fresh air temperature sensor and a fresh air damper are disposed at a fresh air inlet end of the first pipe; the fresh air temperature sensor transmits detected temperature signals to the central control system, which accordingly controls the operation of the fresh air damper and the air conditioning unit.

8. The integrated system of claim 6, wherein the HVAC system further comprises a compressor, an expansion valve, a condenser, and a cooling fan.

9. The integrated system of claim 6, wherein the power battery is configured to supply power to a drive motor of the vehicle, and the drive control system is configured to control the operation of the drive motor.

10. A control method for the integrated system of vehicle air conditioning and a cooling or heating device of claim 2, the method comprising:
sensing a temperature of a power battery or a drive control system via a temperature sensor, when the temperature is outside an effective operating temperature range of the power battery or the drive control system, transmitting a signal to a central control system via the temperature sensor;
controlling, by the central control system, a cooling fan to direct cooled or heated air output from a HVAC system toward the power battery or the drive control system, thereby dissipating heat from or heating the power battery or the drive control system until the temperature of the power battery or the drive control system reaches a predetermined operating temperature range; and
automatically deactivating the cooling fan or reducing a rotational speed of the cooling fan via the central control system.
